(19) United States
(12) Patent Application Publication
(10) Pub. No.: US 2008/0006976 A1
(43) Pub. Date: Jan. 10, 2008

(54) Multiple spacing portable framing jig

(76) Inventor: Tobiah George Heber Riley, Salmon Arm (CA)

Correspondence Address: Tobiah G. H. Riley, P.O. Box 786, Salmon Arm, BC, V1E 4N9, US

(21) Appl. No.: 11/810,127

(22) Filed: Jun. 5, 2007

(30) Foreign Application Priority Data
Jul. 4, 2006 (CA) 2,552,260

(51) Int. Cl. B25B 11/00; E04B 1/00

(52) U.S. Cl. 269/43; 52/741.1

(57) ABSTRACT

A portable framing jig for aiding in the assembly of framed structures includes an elongated device having a main planar segment and a side planar segment that are joined in a right angle relationship. The jig is made of a fracture resistant material such as aluminium or plastic. A plurality of inner stud cradles and outer stud cradles are longitudinally spaced within the main planar segment and consist of a transverse opening into which a stud is seated. The outer stud cradles are located at the either end of the device, while the inner cradles are spaced within it, and together they enable the aligning, bracing and spacing of the ends of studs during the fastening process. Shoulders are located on the main planar segment in alignment with the cradle sides. Each outer stud cradle has within it a removable spacer, which when engaged offsets a stud from the inner surface of the cradle opening to accommodate the unique spacing requirements of the first or last stud of a framing section. The spacer is attached to the inner stud cradle shoulder using a hinge, fasteners, or a key-type of device. Handhold openings are orientated between the outer stud cradle and first inner stud cradle on either end of the jig. Anchoring holes are longitudinally spaced in both the main and side planar segments and through which temporary fasteners secure the jig to a sole plate.

### BACKGROUND OF THE INVENTION

1. Field of Invention

This invention relates to wood framing jigs, specifically to such jigs that are used for aligning, bracing and spacing of structural members during framing of wooden buildings.

2. Prior Art

Wood frame construction methods are used extensively in Canada and the United States. Such construction is based upon using wooden members as the structural support of any building. Standardized dimensioned lumber is used for this purpose, with 2 inches by 4 inches and 2 inches by 6 inches the most common examples. The finished size of this lumber is 1½ inches by 3½ inches or 5½ inches respectively. Completed wall framing consists of horizontally positioned sole and top plates with vertically placed studs sandwiched between them. The studs are spaced along and fastened to the plates at a set interval. In the framing process, the assembly of wall sections may take place horizontally on a flat surface such as a building floor. It may also be done vertically or in place, common when framing basements and attics and other places where there is inadequate room to stand up horizontally framed walls. Such framing is often undertaken by unskilled do-it-yourselfers.

Once wall sections are framed and positioned, panel sheets are generally fastened over the structural framework. Common panel sheets are drywall for interior applications and plywood for the exterior sheathing. These panels come in standard sizes, usually 4 feet by 8 feet, and are designed to align with standardized spacing of structural members such as wall studs. This spacing is normally either 16 inches or 24 inches, measured between the centers of studs. It is integral to the wood framing system of construction that panels are aligned with the studs they are to be fastened to. There is a complication with the standardized spacing in the first and last, or outer, studs of a wall. It is necessary that panels align with the outer edges of these studs. However, for inner wall studs, the panels need to align to the center of the stud to allow the adjacent panel to be fastened on the same stud. This creates a discrepancy in the standardized stud spacing interval for the outer studs that amounts to half the width of a stud, or ¾ of an inch.

Since conforming to the industry standards for stud and structural member spacing is critical for proper panel fastening and placement, there have been numerous attempts to develop a jig to help ensure proper spacing. Traditionally, a measuring tape and pencil were used to manually mark the spacing intervals on the sole and top plate. This method is slow, cumbersome and is prone to errors in unskilled workers. Furthermore, it provides no alignment or bracing aids during the fastening of the studs to the top and sole plates, causing accuracy of placement to vary with each stud and with the attention and skill of individual workers. Numerous attempts have been made in the art to improve upon this traditional method.

Simple replacements for the pencil and measuring tape have been used. U.S. Pat. No. 4,845,858 to Thomas (1989) discloses a continuous rollable tape that has standard stud interval markings on it, and has an adhesive backing to secure it to the bottom and top plates of a wall. This method is highly dependent on the skill of an individual in aligning the tape on the plate, and does not accommodate the spacing discrepancy in outer stud placement. Positioning the tape is laborious, resulting in minimal manpower savings over the traditional method. Additionally, this method gives no physical alignment or bracing during the fastening process, and would be prone to placement spacing errors.

Several types of rigid single stud spacing jigs have been proposed—for example, U.S. Pat. No. 2,744,334 to Jondole (1956), U.S. Pat. No. 3,201,874 to Christy (1965), U.S. Pat. No. 5,628,119 to Bingham et al (1997), and U.S. Patent Application Publication US 2004/0237450 A1 of Barborka. These types of spacing jigs generally have two stud openings that are rigidly spaced a predetermined distance apart. One opening is placed on a previously fastened stud that acts as an anchor, while the other opening positions an unsecured stud. Most of these jigs do not physically align the stud with the plate, causing placement alignment to be dependent on individual skill. The accuracy of stud placement will be dependent on proper positioning of the anchor stud. Furthermore, most of the single stud spacing jigs are positioned along the length of the stud, and are not directly in contact with the sole or top plate. This can allow movement of the stud with respect to the plate during the fastening process, particularly in vertical framing. Additionally, it is not uncommon for studs to be warped or untrue along their length. This would cause inadvertent positioning errors even with correct jig use. Any errors in the placement or spacing of any studs will be cumulative. Such errors can create improper alignment of panel(s) with the studs, preventing them from being properly fastened. This results in decreased productivity for workers who fasten the panels and provide finishing to the inside walls.

The single stud spacing jig is labour intensive. Up to two or more separate jigs are necessary for the proper spacing of each stud, and the jigs need to be repositioned for each stud. These types of jig are generally designed and built for a single stud spacing, such as 16 inches on center. This would mean it is not usable for other common spacings such as 24 inches on center. Additionally, the issue of outer stud spacing is generally not addressed.

In U.S. Patent Application Publication US2006/0010703 A1 by Gauthier, some of the limitations of the single stud spacing jig have been addressed by allowing adjustments for first stud placement and alternate spacings. However, the inherent deficiencies in a single stud spacing jig previously discussed remain. This jig is mainly designed for horizontal framing, and is not suited for vertical framing. Additionally, the enclosing nature of the jig, where it surrounds the stud on both sides, precludes is from being used in vertical corner framing applications.

A multiple stud spacing jig is disclosed in U.S. Pat. No. 2,567,586 to Werder (1951). This jig allows multiple studs to be positioned in a single jig without repositioning, and the jig itself is anchored to the sole plate. Although this reduces potential spacing errors, and provides bracing and alignment of the studs, the jig does not allow for first stud spacing or alternate spacing intervals within the same jig. Its design is inflexible, with each jig's layout accommodating only a specific stud spacing layout. Its heavy, bulky and elaborate angle iron design would make it expensive to manufacture and cumbersome to use. The nature of its design precludes its use for vertical framing, where fasteners are driven through one or both sides of the stud's ends and into the sole plate.

### OBJECTS AND ADVANTAGES

Accordingly, several objects and advantages of the present invention are:
(a) to provide a framing jig that can be used by an unskilled worker;
(b) to provide a framing jig which allows for the special spacing requirements of the outer studs of a wall section;
(c) to provide a framing jig that physically aligns the studs with the sole or top plate at the point of fastening;
(d) to provide a framing jig that braces the stud end during the fastening process, particularly when framing vertically;
(e) to provide a framing jig that is not prone to placement spacing errors;
(f) to provide a framing jig that does not require a previously fastened stud to operate;
(g) to provide a framing jig that ensures proper stud spacing at the point of contact between the plate and stud;
(h) to provide a framing jig which will not allow cumulative spacing errors;
(i) to provide a framing jig which is useful for both vertical in-situ framing and horizontal framing;
(j) to provide a framing jig that increases the efficiency and productivity of the framing process;
(k) to provide a framing jig that allows alternate spacing intervals without any adjustments;
(l) to provide a framing jig that will allow the placement of multiple studs before repositioning is required;
(m) to provide a framing jig that can be used in corner framing applications; and
(n) to provide a framing jig that has a simple design which will make it inexpensive to manufacture.

Further objects and advantages are to provide a framing jig that is anchored to the sole or top plate, ensuring bracing and accurate positioning during the fastening process, that can accommodate studs and structural members that are not perfectly straight and true, that is simple to use, that is robust and reliable, that is of a convenient size and shape to use and move around a job site, that has handholds for easy manipulation and placement, and that can be used repeatedly without any time consuming adjustments. Still further objects and advantages of my invention will become apparent from a consideration of the drawings and ensuring description.

### SUMMARY

In accordance with the present invention a portable framing jig comprises an elongated rigid device having a main planar segment and a side planar segment that are joined in a right angle relationship, a plurality of longitudinally spaced stud cradles in the main planar segment, a spacer in each of the outer stud cradles, a plurality of shoulders that are mounted on the main planar segment in alignment with the sides of each stud cradle opening, and a plurality of anchoring holes in both the main and side planar segments.

### DRAWINGS—FIGURES

FIG. 1 is a front perspective view of the jig.

FIG. 2 is a rear perspective view of the jig.

FIG. 3 is a perspective view of the jig in a vertical framing application with studs mounted at 16-inch centers.

FIG. 4 is a rear view of the jig in a vertical framing application which shows both stud and fastener placement, and a spacer that is engaged and one which is not.

FIG. 5 is a perspective view of two jigs in a horizontal framing application, with studs placed at 16-inch centers.

FIG. 6 is an end view of the two jigs engaged in a horizontal framing application which shows fastener placement.

### DRAWINGS—REFERENCE NUMERALS

| | | | |
|---|---|---|---|
| 10 | main planar segment | 12 | side planar segment |
| 14 | inner cradle | 16 | outer cradle |
| 18 | shoulder | 20 | anchoring hole |
| 22 | spacer | 24 | hinge |
| 26 | handhold opening | 28 | sole plate |
| 30 | stud | 32 | fastener |
| 34 | portable framing jig | 36 | temporary fasteners |
| 38 | top plate | | |

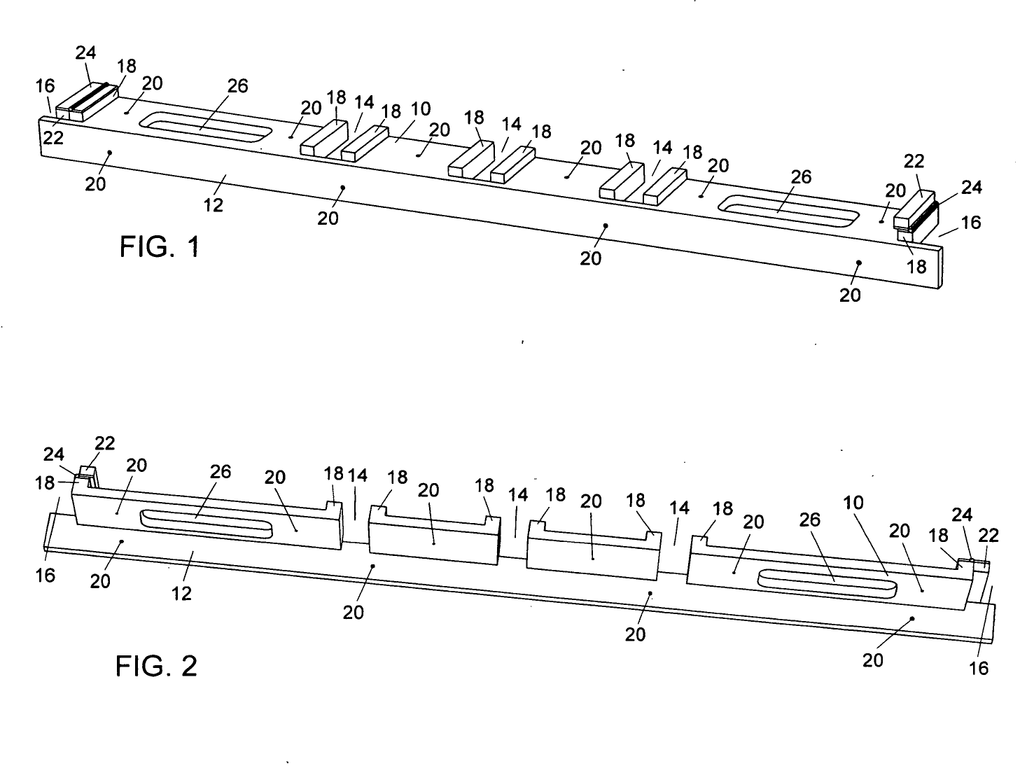

### DETAILED DESCRIPTION—FIGS. 1 AND 2—PREFERRED EMBODIMENT

A preferred embodiment of the jig of the present invention is illustrated in FIG. 1 (front perspective view) and FIG. 2 (rear perspective view). The jig 34 is an elongated device whose length is determined by the number and spacing of inner cradles 14 and outer cradles 16. In its preferred embodiment it is exactly 48 inches in length and has a width and height that permit it to be placed on a sole plate 28 of minimum dimensions 1½ inches high and 3½ inches wide. The width and height of the jig will normally be slightly less than the dimensions of the sole plate to ensure easy fit. The jig can be constructed of any robust and fracture resistant material such as aluminium, polyethylene, polycarbonate and so on. In the preferred embodiment, the jig is made of aluminium and produced in a single cast to minimize its manufacturing expense. The outer corners of the jig are typically rounded to avoid snagging and personal injury.

The jig 34 has a main planar segment 10 that is attached to a side planar segment 12 in a right angle relationship. The thickness of the main planar segment and side planar segment will generally be consistent, and will depend on the type of material used in construction, with stronger materials requiring less thickness for an equivalent strength. Such thickness is expected to range from ⅛ inch to ½ inch. The width of the main planar segment typically will be 3½ inches or less as measured from its underside. Within the main planar segment is a plurality of inner cradles 14 that are longitudinally spaced at predetermined intervals. In the preferred embodiment, there will be 3 inner cradles. They will be longitudinally and symmetrically spaced along the main planar segment at distances of 16 inches, 24 inches, and 32 inches from the end of the jig, with the distances measured from the end of the jig to the center of each inner cradle. The inner cradle is an opening that is approximately 1½ inch wide or slightly greater, and has a length equal to the width of the main planar segment. In the preferred embodiment, each inner cradle will have two shoulders 18, with one shoulder mounted on the main planar segment in alignment with each side of the inner cradle opening. The length of the shoulder will be such that it will extend the length of the cradle. It will have a width of approximately ¾ inch and height of ½ inch, with these measurements ensuring that the shoulder will not interfere with placement of fasteners 32 in a stud's 30 side in the case of vertical framing. If the thickness of the main planar segment is substantial, approximately ½ inch or greater, there may not be any need for the shoulders to provide bracing and positioning support for the studs during fastening.

On each end of the main planar segment is an outer cradle 16. The outer cradle is approximately 1½ inch wide, and is open on its exterior side. The outer cradle has a shoulder 18 that is mounted on the main planar segment 10 in alignment with its interior side. The shoulder of the outer cradle has a spacer 22 attached to it. The spacer may be attached to the shoulder with fasteners, a key type lock, a hinge, and so on. In the preferred embodiment, it is attached with a hinge 24. The hinge may be attached to the spacer and shoulder with fasteners, or in the preferred embodiment, it will be integral to the jig 34. The spacer is the same length as the shoulder, however its width is critical to ensure accurate first stud spacing. The width is half the width of a stud 30, and in the preferred embodiment this is ¾ inch. The spacer height can be up to the combined stacked height of the main planar segment and the shoulder.

In the preferred embodiment, the main planar segment 10 has a handhold opening 26 symmetrically located between the first outer 16 and inner cradle 14 at either end of the main planar segment. The openings are approximately 2 inches wide by 5 inches long, and run parallel to the side planar segment 12. There are 6 anchoring holes 20 longitudinally spaced within the main planar segment, on either side of the handholds, and one centered between each of the inner cradles. The anchoring holes permit temporary fasteners 36 to secure the jig 34 to the sole 28 or top plate 38.

The side planar segment 12 extends the full length of the jig 34. It is integrally attached in a right angle relationship to the main planar segment 10. The height of the side planar segment is typically 1½ inches or less as measured from its backside. The side planar segment also has approximately four anchoring holes 20 longitudinally positioned along its length.

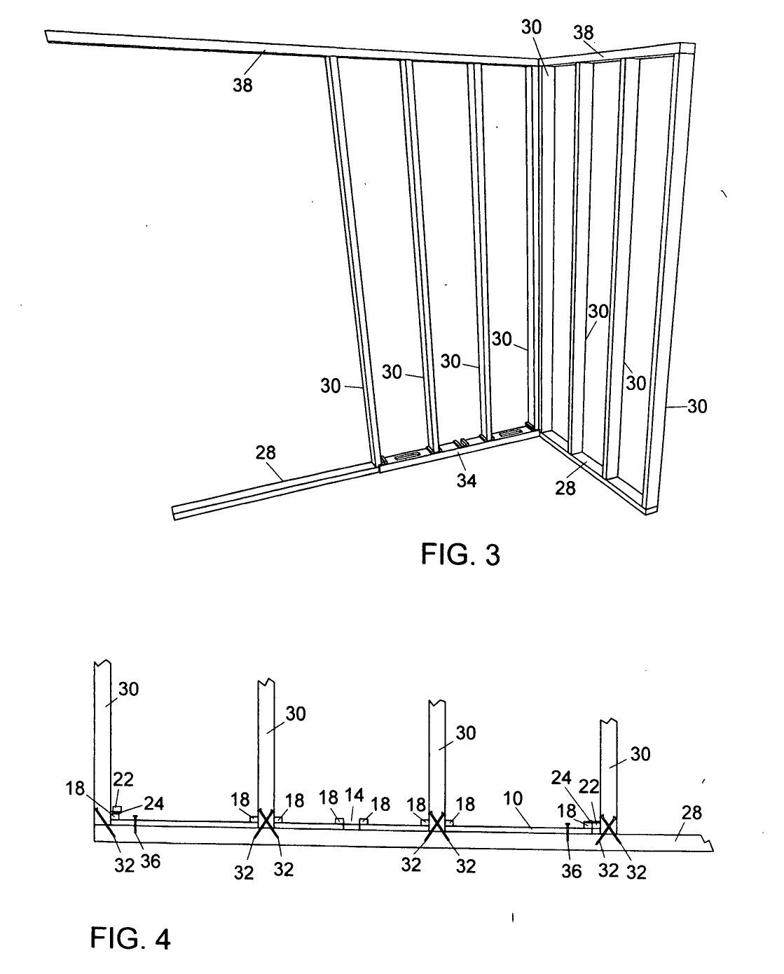

### Operation—FIGS. 3, 4, 5 and 6

The manner of using the multiple spacing portable framing jig is unique to that of jigs in the prior art. One first moves and handles the jig 34 by grasping either of the handhold openings 26 in the main planar segment 10 of the jig. Next, one positions the jig on the chosen sole plate 28 with the underside of the main planar segment resting on the plate. If required, the spacers 22 will be flipped over and engaged so they are adjacent to the outer shoulder 18. Generally, if a first or last stud 30 were to be attached, the corresponding spacer would not be engaged. Next, while holding the jig against the sole plate, one slides the jig until an end of the side planar segment 12 is aligned with the end of the sole plate, or until a prefastened stud is firmly against the shoulder or spacer (if engaged) of the outer cradle. Once in position on the plate, one fastens the jig to the plate with temporary fasteners 36 as required, with the normal requirement being one fastener at either end of the jig.

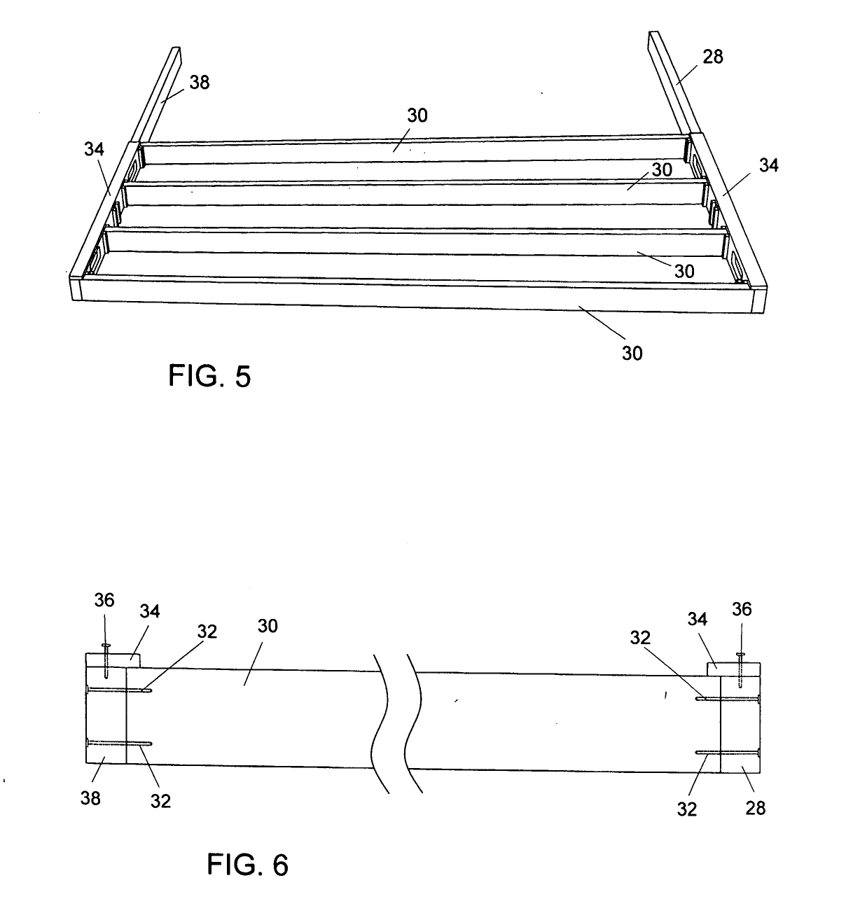

If one were framing horizontally, the above process for fixing the jig 34 to the sole plate 28 would be repeated with a second jig on the top plate 38. The two plates would be positioned parallel and in a mirror image relationship with each other on a flat surface on their edges, with the fastened jigs facing one another. This can be seen in FIG. 5. The initial stud 30 for a new wall section would be placed in the outer cradle 16 of either jig (that are opposite each other), forced against the shoulder 18, and one would install fasteners 32 from the underside of the plate into the stud. This process would be repeated for each of the other studs, choosing the inner cradles 14 that correspond to the desired spacing (16 or 24 inches on center). In FIG. 5, the spacing shown is 16 inches on center. Next, the final stud will be placed in the other outer cradle in a similar manner to the first outer cradle, with the spacer 22 engaged if required. FIG. 6 shows an end view of the horizontal framing assembly, and in particular shows the fastener placement between the plates and studs, and the temporary fasteners 36 securing the jigs to the plates.

If one were framing vertically, the process for fixing the jig 34 to the sole plate 28 would be performed on a plate already fastened in its final place within the wall. The top plate 38 would also be fastened into its final place. This can be seen in FIG. 3. One may repeat the process for fixing a second jig to the top plate as desired, though it would not be a requirement as a level could be used to properly position the stud 30 in relation to the top plate. After fixing the jig(s) to the plate(s), a prefitted stud would be placed in the first outer cradle 16, and would be fastened to the sole plate while holding the stud within the cradle. The fasteners 32 would extend through the stud and into the plate. The other end of the stud would be secured in a similar manner to the outer cradle of the jig in the top plate (if there is one), or a level would be used to manually position the end of the stud onto the top plate. One would fasten it in a similar manner to the sole plate. One would continue in a systematic manner, installing and fastening the studs in the appropriately spaced inner cradles 14. When installing the final outer cradle the spacer 22 would be engaged if appropriate. FIG. 4 shows a rear view of the vertical framing assembly. Fasteners are shown securing the studs at the spacing of 16 inches on center, while temporary fasteners 36 secure the jig to the sole plate. One spacer is engaged, allowing the wall section to continue, while the other is not, representing the beginning of the wall section.

Once all studs 30 are fastened in place, the temporary fasteners 36 in the jig 34 would be removed. The jig would then be removed by gripping the handholds 26 and pulling the jig straight away from the studs. The jig could now be positioned on a new sole plate 28 if the wall is complete, or repositioned further down the plate to continue the framing. The overall process for securing the jig and fastening the studs would be repeated as often as necessary.

### Conclusion, Ramifications, and Scope

Thus, the reader will see that the invention provides a simple, robust, economical and convenient device that can be used by unskilled workers to quickly and easily frame walls in either a vertical or horizontal framing applications. The jig allows the accurate spacing and fastening of multiple studs without the need to adjust or reposition it and without the need for a prefastened anchoring stud. It allows alternate stud spacing intervals without any adjustment, in addition to accommodating the special spacing requirements of the first and last wall studs. The jig physically aligns studs at the point of contact with the plate, and braces the studs during fastening.

While my above description contains many specificities, these should not be construed as limitations on the scope of the invention, but rather as an exemplification of one preferred embodiment thereof. Many other variations are possible. For example, different methods and devices could be employed to secure the jig to the plate. Additionally, different types of handholds or handles might be employed. The cradle widths could be adjusted to accommodate engineered floor joists and the like.

Accordingly, the scope of the invention should be determined not by the embodiments illustrated, but by the appended claims and their legal equivalents.

The embodiments of the invention in which an exclusive property or privilege is claimed are defined as follows:

1. A portable framing jig for aiding in the assembly of framed structures, said jig comprising:
a. an elongated rigid device having a main planar segment and a side planar segment, said planar segments joined in a right angle relationship, and
b. a plurality of stud cradles formed at longitudinally spaced intervals in said main planar segment, each stud cradle consisting of a transverse opening for seating a structural member, said stud cradles consisting of inner stud cradles and outer stud cradles, said outer stud cradles located at the ends of said device, and
c. a spacer located within each outer stud cradle, whereby a structural member will be offset from the inner side of said outer stud cradle opening by the width of said spacer, and
d. means for removing said spacer from the opening, and
e. means for anchoring said device in a fixed position on a structural member.

2. The portable framing jig of claim 1 wherein said means for moving said spacer from said stud cradle opening include a hinge, fasteners, or a key-type of device.

3. The portable framing jig of claim 1 wherein said elongated rigid device is made of aluminium or a rigid plastic.

4. The portable framing jig of claim 1 wherein said stud cradles have a rectangular shape with a lateral width equal to or slightly greater than the width of said structural member.

5. The portable framing jig of claim 1 wherein said stud cradles are longitudinally spaced at intervals of both 16 and 24 inches.

6. The portable framing jig of claim 1 further including a plurality of shoulders, each shoulder mounted upon said main planar segment in alignment with one side of each stud cradle opening, whereby said stud will be braced and retained during the fastening process.

7. The portable framing jig of claim 6 wherein said shoulders have a height whereby fasteners can be inserted into said structural member over said shoulder.

8. The portable framing jig of claim 1 further including a plurality of handholds.

9. The portable framing jig of claim 8 wherein the handholds are openings located within the main planar segment.

10. The portable framing jig of claim 1 wherein the means for anchoring said device includes a plurality of anchoring holes through which temporary fasteners can pass, said anchoring holes located at longitudinally spaced intervals in the main planar segment and side planar segment.

11. A method of assembling framed structures, comprising:
a) providing a portable framing jig of the type comprising an elongated rigid device having a main planar segment and a side planar segment, said planar segments joined in a right angle relationship, a plurality of stud cradles formed at longitudinally spaced intervals in said main planar segment, each stud cradle consisting of a transverse opening for seating a structural member, said stud cradles consisting of inner stud cradles and outer stud cradles, said outer stud cradles located at the ends of said device, a spacer located within each outer stud cradle, whereby a structural member will be offset from the inner side of said stud cradle opening by the width of said spacer, means for removing said spacer from the opening, and means for anchoring said device in a fixed position on a structural member,
b) engaging said spacer if panel spacing requires it,
c) providing a plate and positioning and fastening said portable framing jig upon it,
d) providing a plurality of studs and inserting and fastening said studs into said stud cradles,
e) unfastening and moving said portable framing jig along said plate if said framed structure is unfinished, whereby said framed structure can be easily and quickly assembled by unskilled workers.

12. The method of claim 11 wherein said means for moving said spacer from said stud cradle opening include a hinge, fasteners, or a key-type of device.

13. The method of claim 11 further including a plurality of shoulders, each shoulder mounted upon said main planar segment in alignment with one side of each stud cradle opening, whereby said stud will be braced and retained during the fastening process.

14. The method of claim 11 wherein the means for anchoring said device includes a plurality of anchoring holes through which temporary fasteners can pass, said anchoring holes located at longitudinally spaced intervals in the main planar segment and side planar segment.
